(19) United States
(12) Patent Application Publication
(10) Pub. No.: US 2005/0051920 A1
(43) Pub. Date: Mar. 10, 2005

(54) Methods and devices for in-mold printing on molded parts

(76) Inventor: Joel Thomson, Elka Park, NY (US)

Correspondence Address: Cooper & Dunham LLP, 1185 Avenue of the Americas, New York, NY, 10036, US

(21) Appl. No.: 10/931,764

(22) Filed: Sep. 1, 2004

Related U.S. Application Data
(60) Provisional application No. 60/500,153, filed on Sep. 4, 2003.

(51) Int. Cl. B29C 31/00

(52) U.S. Cl. 264/40.1; 264/255; 425/96; 425/155

(57) ABSTRACT

Apparatus and methods of applying text, graphics, or other coatings to the surface of injection molded plastic parts by injecting a pigmented ink or other liquid through pores in the mold wall during the molding cycle so that parts are molded and printed in one operation.

### CROSS REFERENCE TO RELATED APPLICATIONS

This application claims the benefit of U.S. Provisional Application No. 60/500,153 filed Sep. 4, 2003.

### BACKGROUND OF THE INVENTION

After being molded, most molded parts are typically decorated in a secondary process. The two most common processes are pad printing and heat transfer printing. In pad printing, liquid ink is transferred from an engraved plate to the part surface by means of a silicone elastomer pad. The viscosity and adhesive properties of the ink are critical to ensure sufficient tackiness for transfer. In heat transfer printing, a layer of solid ink is transferred by means of a heated die from a disposable backing film onto the part surface. Both of these processes involve handling the parts into and out of the printing position, and involve additional fixtures and/or dies dedicated to each part and graphic.

In-mold decorating is also used to apply graphics to molded parts. In this process a pre-printed film is placed, usually robotically, into the mold and the plastic melt is caused to flow behind it. The graphic adheres to the part by thermal fusion between the melt and the graphic film. Like the pad printing and heat transfer printing mentioned above, in-mold decorating requires a separate printing operation which is discrete from the molding operation.

Another decorating process is in-mold paint, wherein a liquid paint is injected into the space between a just-molded part and the partially open mold cavity. Although this type of decorating occurs within the mold, additional time is needed for each cycle and accurate printing of discrete patterns, such as a graphic image or text, is not possible.

### SUMMARY OF THE INVENTION

One aspect of the present invention is to provide a mold containing one or more channels or reservoirs whereby ink is caused to flow from a source into close proximity with the mold wall in the desired area to be printed. The mold furthermore contains pores or openings connecting the ink channel(s) with the cavity defining the shape of the molded part(s). The pores are configured in the correct shape to form the desired graphics or text on the part surface.

Another aspect of the present invention is a pumping device to move the ink through the pores. The pumping action is timed to the injection of polymer and can be regulated by time, pressure, volume, or some combination thereof.

A further aspect of the present invention is the ink, a pigment-containing substance which is applied in liquid form and becomes a solid after application to the plastic surface.

Therefore, objects of the present invention, among others, is to provide: (1) a process wherein the steps of molding and printing are combined in a single operation; (2) a process whereby handling and positioning of the molded part is not necessary; (3) a process whereby printing takes place without lengthening the molding cycle time; and (4) a printing process that does not require additional machines, operators or floor space.

One aspect of this invention relates to devices and processes to mark or coat molded parts by injecting liquid ink or another liquid onto the part while still in the mold by means of a plurality of pores or holes in the mold wall that are sized to allow the flow of ink or other liquid but prevent leakage of plastic from the mold.

In one embodiment, the invention employs an air-drying ink, but other ink chemistries and cure methods are equally applicable.

In one embodiment of this invention, a sintered porous metal provides the openings in the mold wall although openings formed by other means are also applicable.

One object of the invention is to provide an apparatus for coating surfaces of objects molded from plastic material having: (a) a mold having a first portion porous to a coating material and not porous to the plastic material, and a second portion not porous to the coating material or the plastic material; (b) a supply system for supplying the coating material to the first portion; and (c) a control system for controlling the supply of the coating material to the first portion. Also, the supply system of the apparatus can have: (1) at least one conduit for supplying the coating liquid through the second portion to the first portion; and/or (2) a reservoir for storing the coating liquid. In addition, the control system of the apparatus can have: (1) a timing controller; (2) an input for receiving a timing signal; and (3) an output for controlling the supply system.

Another object of the invention is provide the mold for the apparatus in which: (1) the mold is primarily formed from a material porous to the coating material and not porous to the plastic material, and the second portion is formed by sealing at least a portion of the surface of the mold; (2) the second portion of the mold is formed from a material not porous to the coating material or the plastic material, and the first portion of the mold is formed from a material porous to the coating material and not porous to the plastic material; (3) the second portion of the mold is formed from a material not porous to the coating material or the plastic material, and the first portion of the mold is formed by providing one or more channels through a portion of the second portion which allow passage of the coating material and prevent passage of the plastic material; (4) the first portion of the mold is chosen from materials selected from the group of sintered stainless steels, stainless steels having channels, and solidified porous metal powders; (5) the second portion of the mold is chosen from materials selected from the group of solid stainless steels, carbon steels, bronzes, aluminums, and solidified non-porous metal powders; (6) the second portion of the mold is sintered stainless steel which has been rendered not porous to the coating material by a process selected from the group of: grinding, electroplating, thermal spray metallizing, and impregnating; and/or (7) the first portion of the mold has an application portion which forms at least part of a wall of the mold and/or has a surface offset from the adjacent portions of the wall.

A further object of the invention is to provide: (1) coating materials for the apparatus which are selected from the group of solvent-dry pad printing inks, UV-cure inks, elastomers, waxes, thermoplastic inks, polyvinyl chloride plastisol inks, heat cure thermosets, two part epoxies, and two part urethanes; and/or (2) plastic material for the objects selected from the group of thermoplastic materials and thermosetting materials.

An additional object of the invention is to provide an apparatus for printing or decorating surfaces of objects molded from thermoplastic material having: (a) a mold having a first portion porous to ink and not porous to the thermoplastic material, and a second portion not porous to the ink or the thermoplastic material; (b) a reservoir for storing the ink; (c) a channel for supplying the ink through the second portion to the first portion; and (d) a control unit for receiving a timing signal and for applying pressure to the reservoir to cause the ink to flow through the channel to the first portion for a period of time.

Yet another object of the invention is to provide a process for coating surfaces of objects molded from plastic material having at least the steps of: (a) filling a mold with a plastic material; and (b) supplying coating material to a first portion of the mold, the first portion being porous to the coating material and not porous to the plastic material and positioned proximate a wall of the mold, so that the coating material coats at least a portion of a surface of an object being molded. Additional steps can include: (a) transmitting a timing signal to a control system and causing the supplying of the coating material in response to the timing system; (b) applying pressurized air to a reservoir of the coating material; and (c) maintaining the pressurized air for a time period.

Yet another object of the invention is to provide a process for coating surfaces of objects molded from plastic materials having the steps of: (a) filling a mold with a plastic material; (b) transmitting a timing signal to a control system based on the filling step; (c) applying pressurized air to a reservoir of the coating material; (d) maintaining the pressurized air for a time period so as to supply the coating material to a first portion of the mold, the first portion being porous to the coating material and not porous to the plastic material, so that the coating material coats at least a portion of a surface of an object being molded; and (e) removing the object from the mold.

### BRIEF DESCRIPTION OF THE DRAWINGS

The above and other features and advantages of this invention will become appreciated as the same becomes better understood with reference to the remainder of this specification, the claims and drawings wherein:

FIG. 1 is a schematic diagram illustrating one embodiment of the present invention;

FIG. 2 is a schematic diagram illustrating a mold according to one embodiment of the present invention wherein the mold is constructed entirely or primarily of porous material;

FIG. 3 is a schematic diagram illustrating a mold according to one embodiment of the present invention wherein the mold is constructed with a sintered porous insert;

FIG. 4 is a schematic diagram illustrating a mold according to one embodiment of the present invention wherein the mold is constructed with drilled pores; and

FIG. 5 is a schematic diagram illustrating a mold according to one embodiment of the present invention wherein the mold is constructed with selective porous areas.

### DETAILED DESCRIPTION OF THE INVENTION

Thermoplastic materials are known to have large molecules which will not penetrate small openings in a mold even when under the pressures of 100 to 200 megaPascals typically employed in injection molding. Indeed, every well constructed mold employs vents of 50 micrometers or less to allow air to escape as the thermoplastic melt enters. Although these vents are usually ground into parting surfaces of the mold, that is, where the mold splits to remove the part, venting is often necessary in other places within the mold due to the plastic flow pattern. For this reason, companies such as D-M-E Company of Madison Heights, Mich. and International Mold Steel, Inc. of Florence, Ky. sell sintered vents containing pores which allow air but not polymer melt to flow through. These vents are usually cylindrical and can be placed in strategic locations in a mold to allow trapped air to escape.

Experiments performed in developing this invention have shown that such porous materials can be used to not only segregate polymer melt from air, but also polymer melt from other liquids, specifically inks, see Examples 1-4 below. The pigment particles used in pad printing and screen printing inks are typically around 2 micrometers across and the viscosity of such ink is typically much lower than that of a polymer melt.

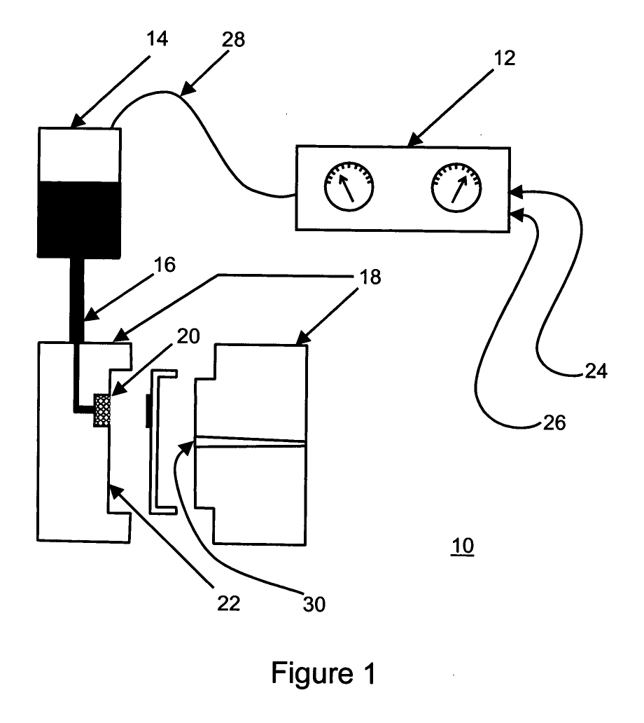

As shown in FIG. 1, in one embodiment of the present invention, the apparatus 10 has four components. These components are a control system 12, an ink reservoir 14, a conduit means for conducting ink 16, and a mold 18 provided with one or more porous areas 20 within the cavity 22. The mold can be used on a standard thermoplastic injection molding machine (not shown). In operation, the injection molding machine fills the mold 18 with thermoplastic material, for example polyethylene, polystyrene, polycarbonate, or polypropylene, at typical temperatures such as 200° to 30° C. The mold 18 is also typically provided with water cooling and maintained at temperatures of 15° to 70° C. The control system 12 is provided with a timing signal 26 from the injection molding machine and an energy source 24, such as, for example compressed air, hydraulic pressure, or electricity.

In one embodiment of the present invention, compressed air 28 pressurized to 0.3 to 0.6 megaPascals is applied to the ink reservoir 14 for a time period of 1-10 seconds, immediately after the mold cavity 22 is filled with thermoplastic melt. The volume of ink deposited on each part is usually small since ink layers typically are only a few micrometers thick.

Because the injection of ink 16 before the melt enters the cavity 22 can cause the ink to smear in the direction of melt flow, and injection of ink after the melt has started to cool and shrink can cause the ink to spread outside the intended area through the gap between the plastic surface and the cavity wall, the correct timing of ink injection is important.

As discussed above, such timing can be achieved by injecting the ink just after injection of the plastic melt which is when a typical mold 18 is held under pressure for a few seconds, typically one to thirty seconds. This time period allows the plastic melt in the plastic injection gate 30 to freeze (solidify) to prevent back flow out of the cavity 22 and to raise the internal pressure in the cavity to offset shrinkage as the plastic cools. In other words, the start of the gate 30 freezing time period and the start of ink injection should coincide. After this packing/freezing stage, more time is usually required so the part in the cavity 22 can solidify enough to keep its shape after leaving the mold 20. This additional time period depends entirely on the material and the wall thickness, but typically ranges from 1 to 250 seconds and more typically from 10 to 30 seconds. During this time period, the ink injection can be completed and if the ink is chemically cured by the heat of the plastic melt or reacts in some way with a chemical in the plastic melt, the ink can be at least partially solidified. It is therefore possible to add the injection function without extending the cycle time for manufacture of the molded part.

The mechanism of solidification of the ink can be solvent release, physical cooling, ultraviolet (UV) photo polymerization, or curing with heat, air or moisture. For some types of ink, additional equipment may be necessary to complete the curing process after the part is ejected from the mold. The ink is usually a single component but can be modified by the addition of thinners, hardeners, accelerators, retarders, or other additives. The ink may contain metallic or other such particles as long as they are ground small enough to penetrate the pores in the mold. Among others, some coating liquids or inks that can be used are solvent dry-pad printing inks, UV-cure inks, elastomers, waxes, thermoplastic inks, polyvinyl chloride (PVC) plastisol inks, heat cure thermosets, two part epoxies, and two part urethanes.

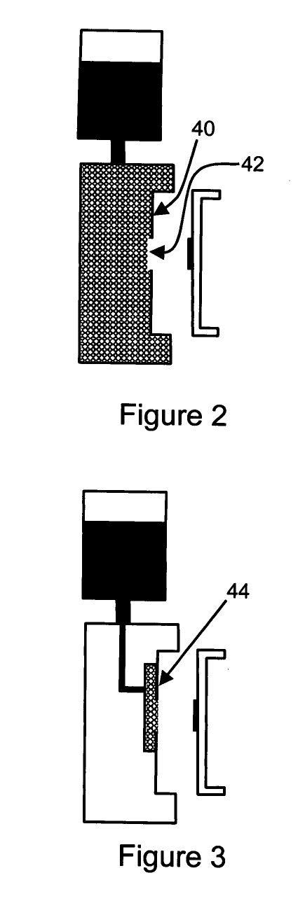

In FIG. 2, the mold 18 half producing the side of the part to be decorated is machined out of a porous material, for example sintered stainless steel. Surfaces 40 which are intended to be impermeable to ink are sealed by one or more of the following methods—grinding the surface to smear the pores shut, electroplating with copper, nickel or chrome, thermal spray metallizing, or impregnating the surface with a polymeric material such as epoxy. Porous areas 42 that are intended to print are caused to be permeable by one or more of the following methods—electrical discharge machining through the sealing layer, laser ablation through the sealing layer, or masking prior to application of the sealing layer.

In FIG. 3, the mold 18 is constructed with the same techniques described above with the exception that porous material is machined to form only a portion 44 of the mold cavity. Selective areas of the cavity surface are caused to be permeable or impermeable as described above.

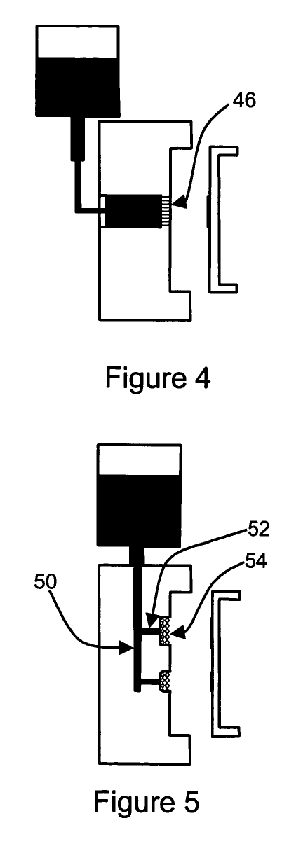

In FIG. 4, the mold 18 is constructed with ink channels machined from the back of the cavity 22 insert to just below the areas to be printed. Sufficient mold material, typically P20 (American Iron and Steel Institute) steel, is left on the surface of the cavity 22 to resist the pressures of injection. Among other materials, the solid mold material can be stainless steels, carbon steels, bronzes, and aluminums. A plurality of substantially round holes 46 are drilled by means of laser or electron beam through the remaining cavity wall 48 in the areas where printing is desired. These areas may be depressed or built up in the cavity wall 48 depending on whether the finished graphics are intended to be raised or depressed on the plastic part. The holes 46 typically measure 50 micrometers or less and are spaced close enough to give the appearance of a solid printed area. The holes render the drilled portion porous to the ink but not porous to the thermoplastic melt. Alternatively, slots of similar width may be used instead of or in conjunction with the holes.

In FIG. 5, the mold 18 is constructed with ink channels 50, 52 communicating through relatively large (>100 micrometers) holes 52 into deeply engraved pockets 54 in the cavity surface. These pockets 54, shaped according to the desired graphic, are filled with a uniformly porous material 56, typically metallic, which may be either machined to fit the pockets, or preferably sintered in place from powder.

The embodiments described above are some of the ways a mold 18 with inking pores can be constructed. There are of course other ways to achieve the same result, for instance selective laser melting, a process developed by the Frauenhofer Institute for Laser Technology in Aachen, Germany. This process uses a laser to melt layers of metal powder into either fully dense metal or porous metal depending on the intensity of the computer controlled laser. In this way mold cavities or inserts can be produced automatically with a selectively porous printing surface.

Although the invention has been described in terms of thermoplastic material, it is also applicable to printing on injection moldable thermosetting materials such as phenolic or melamine. Furthermore, while the invention has been described in terms of injection molding, it is also applicable to other plastic molding processes such as compression molding, blow molding, and thermoforming.

Although the invention has been described in terms of pigmented ink to produce a visual graphic, it may be desirable to selectively coat a part for some other reason, for instance to apply selective areas of elastomer to define a hand grip. The plurality of pores or holes in the mold wall described above may also be used to admit such a material onto the surface of the primary part, instead of ink. The process is the same except for the addition of heating means to keep the said secondary material fluid. Due to the higher viscosity of such materials the pores may be larger and the injection pressure higher as well.

### EXAMPLE 1

A 3 millimeter diameter circular insert of porous stainless steel was pressed into the cavity wall of an aluminum mold. The mold was mounted on a 500 kiloNewton, 170 gram injection molding machine from Ferromatic Milacron Inc. of Batavia, Ohio. Parts with 2.5 millimeter wall thickness were molded out of an acrylonitrile-butadiene-styrene (ABS) plastic (Bayer Lustran 248 from Bayer AG of Leverkusen, Germany). Standard solvent-dry pad printing ink (Visprox TCP 9000 black from Visprox BV of Haarlem, Netherlands) was added to a connected ink reservoir. Compressed air at 0.345 megaPascals was applied for 5 seconds immediately after injection. The resulting parts had a circular ink imprint closely matching the shape of the porous insert.

### EXAMPLE 2

Same as Example 1 except the ink was a UV-cure ink (Nazdar N3100 from Nazdar Inc. of Shawnee, Kans.) which was cured after de-molding with a UV lamp.

### EXAMPLE 3

A similar porous insert was ground to shut the pores, following which a graphic character was machined 0.12 millimeter into the surface with electrical discharge machining (EDM). When the mold was used in the way described above, only the EDM machined graphic character was printed.

### EXAMPLE 4

A sintered bronze insert of 12 millimeter diameter was first ground and electroplated with copper to render the surface impermeable. A graphic character was EDM machined 0.08 millimeter deep, through the copper plating into the porous interior. When inserted into the mold as above, again only the machined character came out printed with ink.

In Examples 1-4, the production time did not increase and no further processing of the parts was necessary.

While the present invention has been described in terms of specific embodiments, this invention encompasses all variations and modifications, including expedients by those skilled in the art, which come within the spirit of the specification and the scope of the appended claims.

1. An apparatus for coating surfaces of objects molded from plastic material comprising:
a mold having a first portion porous to a coating material and not porous to the plastic material, and a second portion not porous to the coating material or the plastic material;
a supply system for supplying the coating material to the first portion; and
a control system for controlling the supply of the coating material to the first portion.

2. An apparatus as in claim 1, wherein the first portion further comprises:
an application portion which forms at least part of a wall of the mold.

3. An apparatus as in claim 1, wherein the supply system comprises:
at least one conduit for supplying the coating liquid through the second portion to the first portion.

4. An apparatus as in claim 1, wherein the supply system further comprises:
a reservoir for storing the coating liquid.

5. An apparatus as in claim 1, wherein the control system comprises:
a timing controller;
an input for receiving a timing signal; and
an output for controlling the supply system.

6. An apparatus as in claim 1, wherein:
the mold is primarily formed from a material porous to the coating material and not porous to the plastic material; and
the second portion is formed by sealing at least a portion of the surface of the mold.

7. An apparatus as in claim 1, wherein:
the second portion of the mold is formed from a material not porous to the coating material or the plastic material; and
the first portion of the mold is formed from a material porous to the coating material and not porous to the plastic material.

8. An apparatus as in claim 1, wherein:
the second portion of the mold is formed from a material not porous to the coating material or the plastic material; and
the first portion of the mold is formed by providing one or more channels through a portion of the second portion which allow passage of the coating material and prevent passage of the plastic material.

9. An apparatus as in claim 1, wherein the first portion further comprises:
an application portion having a surface offset from the adjacent portions of the wall.

10. An apparatus as in claim 1 wherein:
the first portion comprises materials selected from the group of sintered stainless steels, stainless steels having channels, and solidified porous metal powders.

11. An apparatus as in claim 1 wherein:
the second portion comprises materials selected from the group of solid stainless steels, carbon steels, bronzes, aluminums, and solidified non-porous metal powders.

12. An apparatus as in claim 1 wherein:
the second portion comprises sintered stainless steel which has been rendered not porous to the coating material by a process selected from the group of: grinding, electroplating, thermal spray metallizing, and impregnating.

13. An apparatus as in claim 1 wherein:
the coating material comprises materials selected from the group of solvent-dry pad printing inks, UV-cure inks, elastomers, waxes, thermoplastic inks, polyvinyl chloride plastisol inks, heat cure thermosets, two part epoxies, and two part urethanes.

14. An apparatus as in claim 1 wherein:
the plastic material comprises materials selected from the group of thermoplastic materials and thermosetting materials.

15. An apparatus for printing or decorating surfaces of objects molded from thermoplastic material comprising:
a mold having a first portion porous to ink and not porous to the thermoplastic material, and a second portion not porous to the ink or the thermoplastic material;
a reservoir for storing the ink;
a channel for supplying the ink through the second portion to the first portion; and
a control unit for receiving a timing signal and for applying pressure to the reservoir to cause the ink to flow through the channel to the first portion for a period of time.

16. A method for coating surfaces of objects molded from plastic material comprising the steps of:
filling a mold with a plastic material; and
supplying coating material to a first portion of the mold, the first portion being porous to the coating material and not porous to the plastic material and positioned proximate a wall of the mold, so that the coating material coats at least a portion of a surface of an object being molded.

17. A method as in claim 16, further comprising the steps of:
transmitting a timing signal to a control system;
causing the supplying of the coating material in response to the timing system.

18. A method as in claim 16, wherein the supplying step comprises the steps of:
applying pressurized air to a reservoir of the coating material; and
maintaining the pressurized air for a time period.

19. A method for coating surfaces of objects molded from plastic materials comprising the steps of:
filling a mold with a plastic material;
transmitting a timing signal to a control system based on the filling step;
applying pressurized air to a reservoir of the coating material;
maintaining the pressurized air for a time period so as to supply the coating material to a first portion of the mold, the first portion being porous to the coating material and not porous to the plastic material, so that the coating material coats at least a portion of a surface of an object being molded; and
removing the object from the mold.
